(19) United States
(12) Patent Application Publication
(10) Pub. No.: US 2009/0127850 A1
(43) Pub. Date: May 21, 2009

(54) Coupling head and connecting tube assembly structure

(76) Inventor: Ming Jen Chen, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/984,262

(22) Filed: Nov. 15, 2007

(51) Int. Cl. F16L 25/04

(52) U.S. Cl. 285/332.2

(57) ABSTRACT

A coupling head and connecting tube assembly structure comprises a coupling head having an external-threaded section to fit to a connecting tube wherein the coupling head has a hollow bore extending through the interior to which the connecting tube is joined therewith. Furthermore, the connecting tube has the internal surface synchronically pressed by multiple dotted-punching forces so that the internal surfaces of both connecting tube and coupling head synchronically depressed by the dotted-punching forces exerting thereon can form multiple positioning points that are reciprocally bound to each other so as to combine the coupling head and connecting tube into one unit, facilitating easy and speedy assembly thereby.

### BACKGROUND OF THE INVENTION

The present invention relates to a coupling head and connecting tube assembly structure, comprising a coupling head having a hollow bore extending there-through to which the connecting tube is joined wherein the connecting tube has the internal surface synchronically pressed by multiple dotted-punching forces, permitting the internal surfaces of both coupling head and connecting tube synchronically depressed by the dotted-punching forces to form multiple positioning points that are reciprocally bound to each other and combined into one unit thereby, facilitating easy and speedy assembly to boost competitiveness and fit to economical efficiency thereby.

A conventional coupling head 1 (referring to FIG. 6) and connecting tube 2 assembly structure includes a sprinkling head 3 having a sleeve tube 31 extending at one side, and a watertight ring 32 fixed into the sleeve tube 31 defined by an internal-threaded section 311 therein. The coupling head 1 is equipped with an external-threaded section 11 to secure to the internal-threaded section 311 of the sleeve tube 31 thereby. The coupling head 1 also has an appropriate-length tube section 12 extending at the end section, to which a sealing ring 121 is mounted, for the engagement of the connecting tube 2 therewith wherein a groove 13 is defined between the tube section 12 and the external-threaded section 11 thereof. And the connecting tube 2 is equipped with a front end 21 that is roll-pressed to fix into the groove 13 and combine with the connecting tube 1 into one unit.

There are some drawbacks to such conventional coupling head and connecting tube assembly structure. Most of all, the front end 21 of the connecting tube 2 is mounted to the coupling head 1 before pressed and fixed into the groove 13 therein. As a result, the conjoining section thereof can form a depressed mark which is not good in the looks. Besides, the connecting tube 2 is joined to the coupling head 1 simply via a small section extending at the front end 21 thereof. In application, high-pressure water flow to be transported to the sprinkling head 3 will flush first through the interior of the connecting tube 2 before flowing through that of the coupling head 1 to enter the sprinkling head 3 for ejection outwards there-from. Thus, the conventional coupling head and connecting tube assembly structure can fail to bear the total pressure of water flow flushing through the connecting tube 2, the coupling head 1, and the sprinkling head 3 in a sequence for emitting outwards.

Please refer to FIGS. 7, 8. Another conventional coupling head and connecting tube assembly structure is provided wherein a ringed coupling head 1′ has the internal middle section defined by annular alternately-arranged grooves 11′ thereon, and a connecting tube 2′ is mounted into the coupling head 1′ thereof. Then, the internal surface of the connecting tube 2′ is roll-pressed at the position counterpart to that of the grooves 11′ till the connecting tube 2′ is bound and fixed to the grooves 11′ to complete the assembly thereof.

The second conventional coupling head and connecting tube assembly structure features some disadvantages as well. First, the coupling head 1′ must have the grooves 11′ lathed onto the internal surface thereon, which will increase the cost of processing thereof. And, the connecting tube 2′ mounted into the coupling head 1′ must be pressed according to the position of the grooves 11′ so as to combine the coupling head 1′ and the connecting tube 2′ into one unit. As a result, the connecting tube 2′ must have the internal surface repeatedly roll-pressed till fitted to the precise position of the grooves 11′ so that the internal surface of the connecting tube 2′ can be deformed to bind with the depressed grooves 11′, completing the assembly thereof. In the process of roll-press operation, the connecting tube 2′ must be constantly examined to see if matched to the position of the grooves 11′, which is quite troublesome in assembly.

### SUMMARY OF THE PRESENT INVENTION

It is, therefore, the primary purpose of the present invention to provide a coupling head and connecting tube assembly structure, comprising a coupling head having a hollow bore extending there-through to which a connecting tube is joined therewith wherein the connecting tube has the internal surface synchronically pressed by multiple dotted-punching forces, permitting the internal surfaces of both coupling head and connecting tube synchronically depressed by the dotted-punching forces exerting thereon to form multiple positioning points that are reciprocally bound to each other and combined into one unit thereby, facilitating easy and speedy assembly to boost its competitiveness and fit to economical efficiency thereby.

### BRIEF DESCRIPTION OF THE DRAWINGS

FIG. 1 is an exploded perspective view of the present invention.

FIG. 2 is an assembled perspective and partially cross sectional view of the present invention.

FIG. 3 is an assembled cross sectional view of the present invention.

FIG. 4 is a perspective and cross sectional view of the present invention.

FIG. 5 is a diagram showing the present invention in application.

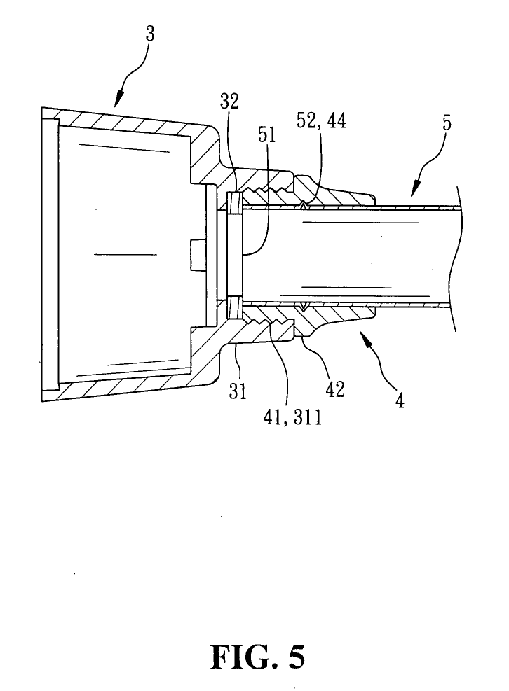

FIG. 6 is an assembled cross sectional view of a conventional coupling head and connecting tube assembly structure.

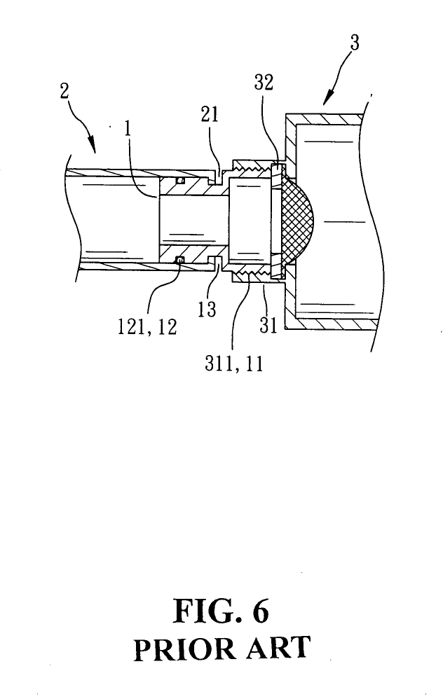

FIG. 7 is an exploded perspective view of another conventional coupling head and connecting tube assembly structure.

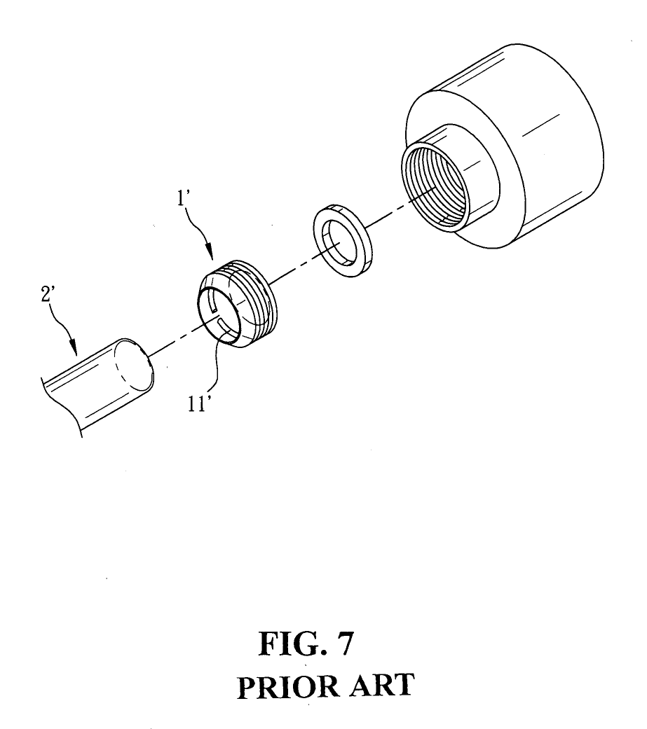

FIG. 8 is an assembled cross sectional view of the second conventional coupling head and connecting tube assembly structure.

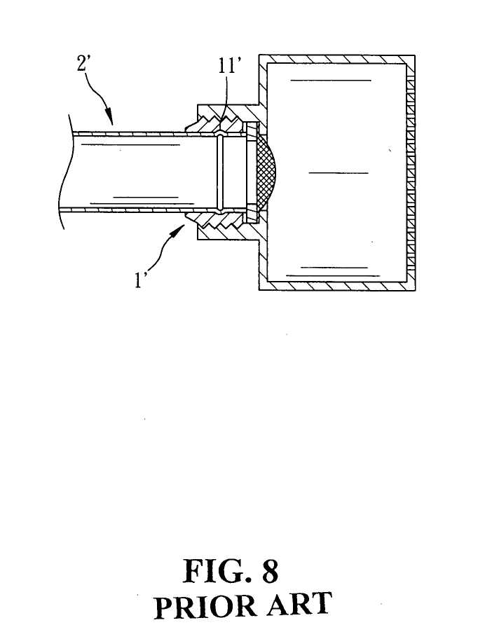

### DETAILED DESCRIPTION OF THE PREFERRED EMBODIMENTS

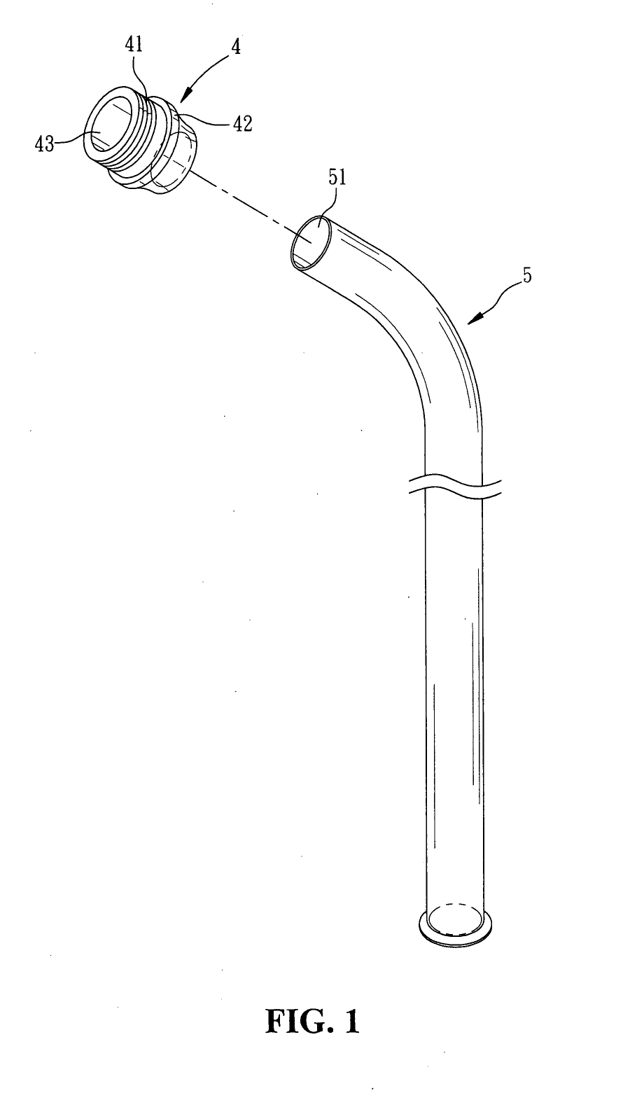

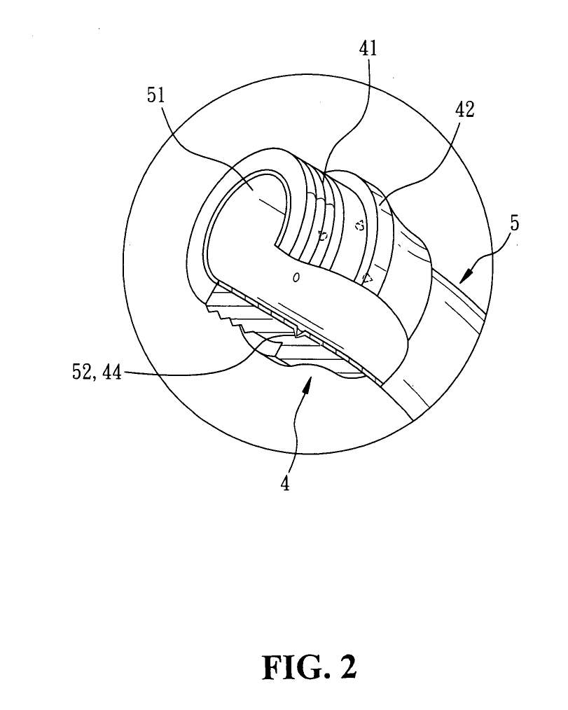

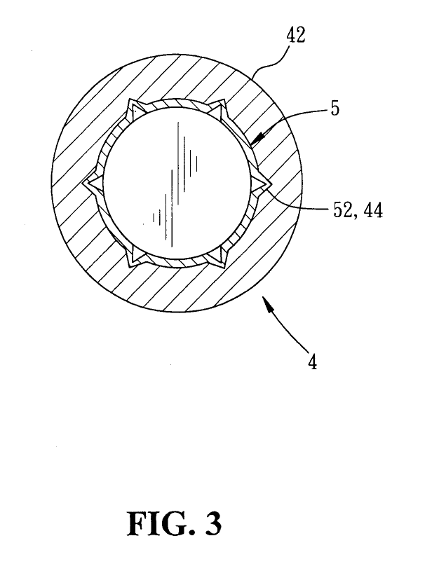

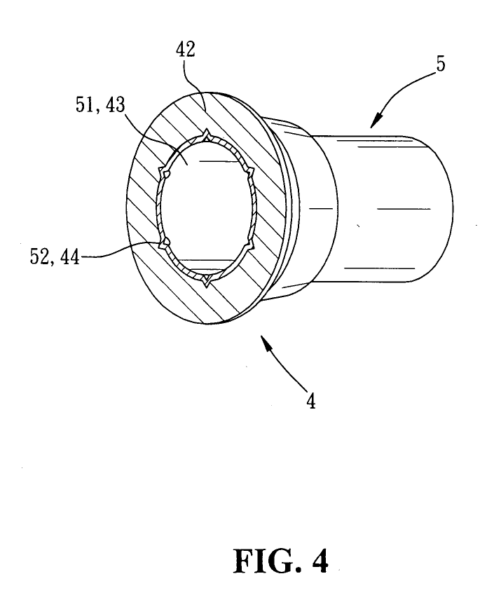

Please refer to FIGS. 1 to 4 inclusive. The present invention relates to a coupling head and connecting tube assembly structure, comprising a coupling head 4 equipped with an external-threaded section 41, and a connecting tube 5 to fit to the coupling head 4 thereof. The coupling head 4 has a stop ring 42 protruding at the middle section thereon, and a hollow bore 43 extending through the interior therein for the engagement of the connecting tube 5 therewith. Furthermore, the connecting tube 5 has the internal surface synchronically pressed by multiple dotted-punching forces thereon so that the internal surfaces of the connecting tube 5 and the coupling head 4 synchronically depressed by the dotted-punching forces exerting thereon will form multiple positioning points 52, 44 that are reciprocally bound to each other so as to combine the coupling head 4 and the connecting tube 5 into one unit thereby. The positioning points 52, 44 are precisely located at the inner side counterpart to the position of the stop ring 42 thereof. Thus, the coupling head 4 can hold the forces of punching pressure and maintain the best conjoining position thereby, facilitating easy and speedy assembly to fit to the competitiveness and the economical efficiency thereby. In application, a sprinkling head 3 equipped with a sleeve tube 31 can have a watertight ring 32 accommodated into the sleeve tube 31 first, and the sleeve tube 31 can have an internal-threaded section 311 secured to the external-threaded section 41 of the coupling head 4 till the watertight ring 32 synchronically sealed tight onto a front edge 51 of the connecting tube 5 and the end surface of the coupling head 4 thereby. Therefore, water flow can be transported from the connecting tube 5 into the sprinkling head 3 to be emitted outwards there-from without leaking outwards at the locking position of the internal-threaded section 311 and the external-threaded section 41, achieving anti-leakage purpose thereby.

What is claimed is:

1. A coupling head and connecting tube assembly structure, comprising a coupling head equipped with an external-threaded section to fit to a connecting tube thereby wherein the coupling head has a hollow bore extending through the interior therein to which the connecting tube is guided and joined therewith; furthermore, the connecting tube has the internal surface synchronically pressed by multiple dotted-punching forces thereon so that the internal surfaces of both connecting tube and coupling head synchronically depressed by the dotted-punching forces exerting thereon will form multiple positioning points that are reciprocally bound to each other so as to combine the coupling head and the connecting tube into one unit thereby; the coupling head also has a stop ring protruding at the middle section thereon, and the positioning points are precisely located at the inner side counterpart to the position of the stop ring; therefore, the coupling head can hold the forces of punching pressure and maintain the best conjoining position, facilitating easy and speedy assembly thereby.
